(19) United States
(12) Patent Application Publication
(10) Pub. No.: US 2024/0414103 A1
(43) Pub. Date: Dec. 12, 2024

(54) COMPUTING SYSTEM

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP)

(21) Appl. No.: 18/700,887

(22) PCT Filed: Dec. 7, 2021
(86) PCT No.: PCT/JP2021/044889

§ 371 Date: Apr. 12, 2024

(51) Int. Cl. H04L 49/118; H04L 47/2483

(52) U.S. Cl. CPC H04L 49/118; H04L 47/2483

(57) ABSTRACT

A computing system includes top-of-rack switches, a spine switch, and PIN blades arranged between the top-of-rack switches and resource blades. Each of the PIN blades includes a plurality of processing blocks, and each of the processing blocks includes a functional unit that performs predetermined processing on data included in the received packet.

### CROSS-REFERENCE TO RELATED APPLICATIONS

This application is a national phase entry of PCT Application No. PCT/JP2021/044889, filed on Dec. 7, 2021, which application is hereby incorporated herein by reference.

### TECHNICAL FIELD

The present invention relates to a computing system in which resource blades are interconnected by a network.

### BACKGROUND

A computing system of a data center in related art is constructed by using a server. Various resources (CPU, memory, storage, accelerator) necessary for a calculation task are mounted on the server little by little. These resources are tightly integrated by a bus. A computing system in which a plurality of servers are prepared and interconnected by a network is a currently typical computing system of a data center.

Such server-centric architectures have been mainstream for many decades. In contrast, recently, a disaggregated data center (DDC) has been proposed in which resources such as a central processing unit (CPU) and a memory are used as resource blades for each function of the resources, and the resource blades are interconnected by a network fabric (see Non Patent Literature 1).

In the DDC in which the resources are separated, each resource technology can easily independently advance, and a period until adoption can be shortened by avoiding a burden such as integration and rework of mother board design.

FIG. 4 is a block diagram illustrating a network configuration of the DDC. Resource blades such as CPU blades 100-1, 100-2, accelerator blades 101-1, 101-2, and storage blades 102-1, 102-2 are connected to upper top-of-rack (ToR) switches 103-1, 103-2. The ToR switches 103-1, 103-2 are connected to each other via a spine switch 104.

In the disaggregated computing technology as illustrated in the example of FIG. 4, the number of devices to be connected dramatically increases as compared with a computing system in related art, and thus, there is a problem that congestion easily occurs in a network. For example, congestion due to access concentration on the TOR switch and the spine switch and fluctuation of a delay due to access via the ToR switch become problems.

### CITATION LIST

### Non Patent Literature

Non Patent Literature 1: Peter X. Gao, et al., “Network requirements for resource disaggregation” 12th USENIX symposium on operating systems design and implementation (OSDI'16), 2016

### SUMMARY

### Technical Problem

Embodiments of the present invention have been made to solve the above problems, and an object of embodiments of the present invention is to provide a computing system capable of reducing a possibility of occurrence of congestion in a network.

### Solution to Problem

A computing system of embodiments of the present invention includes: a plurality of top-of-rack switches that connect subordinate resource blades; a spine switch that connects the plurality of top-of-rack switches; and a plurality of PIN blades arranged between the top-of-rack switches and subordinate resource blades thereof, each of the PIN blades includes a plurality of processing blocks, each of the processing blocks includes a first packet reception unit that receives a packet from the subordinate resource blade; a first packet transmission unit that transmits a packet to the subordinate resource blade; a second packet reception unit that receives a packet from the upper top-of-rack switch; a second packet transmission unit that transmits a packet to the upper top-of-rack switch, a functional unit that performs predetermined processing on data included in a received packet; and a flow ID switch that determines a transfer destination of the data included in the packets received by the first and second packet reception units or the data processed by the functional unit, from the first and second packet transmission units and the functional unit and transfer the data to the transfer destination.

In addition, in one configuration example of the computing system of embodiments of the present invention, a plurality of processing blocks in each of the PIN blades are connected to each other, and the flow ID switch of each of the processing blocks receives data from another processing block in the same PIN blade in addition to the data included in the packets received by the first and second packet reception units and the data processed by the functional unit, determines a transfer destination of the received data from other processing blocks in the same PIN blade as the first and second packet transmission units and the functional unit and transfers the data to the transfer destination.

Further, in one configuration example of the computing system of embodiments of the present invention, the first packet reception unit restores data from the packet received from the resource blade, adds a flow ID corresponding to transmission destination information included in the received packet to the data and transfers the data to the flow ID switch, the second packet reception unit restores data from the packet received from the top-of-rack switch, adds a flow ID corresponding to the transmission destination information included in the received packet to the data and transfers the data to the flow ID switch, the flow ID switch determines a transfer destination of the data on the basis of the flow ID added to the received data, the first packet transmission unit packetizes the data received from the flow ID switch, sets the transmission destination information corresponding to the flow ID added to the received data in the packet and transmits the packet to the resource blade, and the second packet transmission unit packetizes the data received from the flow ID switch, sets the transmission destination information corresponding to the flow ID added to the received data in the packet and transmits the packets to the top-of-rack switch.

In addition, in one configuration example of the computing system of embodiments of the present invention, the functional unit performs processing of any of compression of data, decompression of compressed data, resizing of an image, and channel division of an image.

### Advantageous Effects of Embodiments of the Invention

According to embodiments of the present invention, PIN blades are provided between top-of-rack switches and subordinate resource blades thereof, and first and second packet reception units, first and second packet transmission units, functional units, and a flow ID switch are provided in each processing block of the PIN blades. In embodiments of the present invention, data is processed and transmitted by the functional units of the PIN blades in communication between resource blades, so that load of a network can be reduced, and a possibility that congestion occurs in the network can be reduced.

### BRIEF DESCRIPTION OF THE DRAWINGS

FIG. 1 is a block diagram illustrating a configuration of a computing system according to an embodiment of the present invention.

FIG. 2 is a block diagram illustrating a configuration of a PIN blade according to the embodiment of the present invention.

FIG. 3 is a block diagram illustrating a detailed configuration of the PIN blade according to the embodiment of the present invention.

FIG. 4 is a block diagram illustrating a network configuration of a DDC.

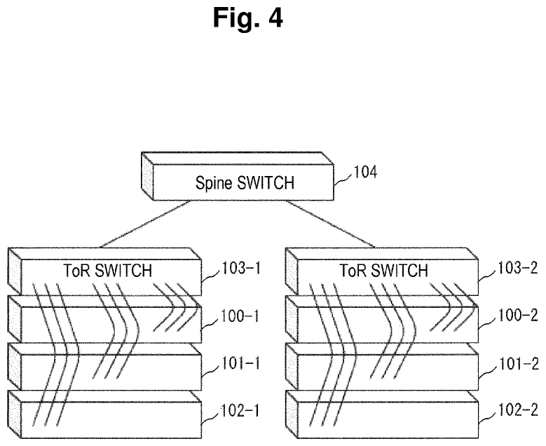

### DETAILED DESCRIPTION OF ILLUSTRATIVE EMBODIMENTS

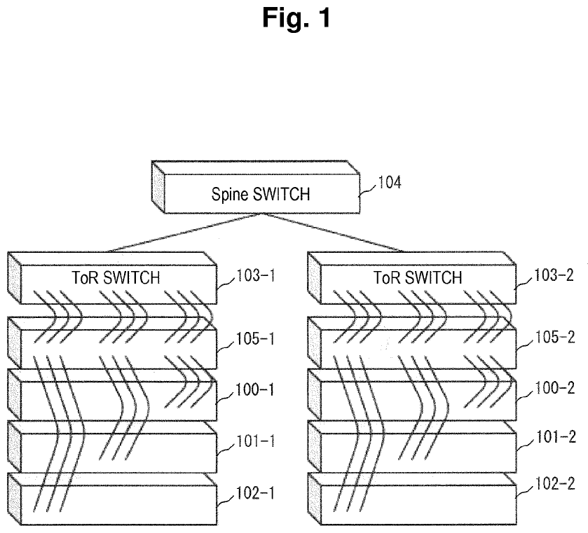

Hereinafter, an embodiment of the present invention will be described with reference to the drawings. FIG. 1 is a block diagram illustrating a configuration of a computing system according to an embodiment of the present invention. The computing system of the present embodiment includes a plurality of top-of-rack (ToR) switches 103-1, 103-2 connecting subordinate resource blades, a spine switch 104 connecting a plurality of ToR switches 103-1, 103-2, and a plurality of processing-in-network (PIN) blades 105-1, 105-2 arranged for each ToR switch between the ToR switches 103-1, 103-2 and the subordinate resource blades thereof.

As described above, examples of the resource blades include CPU blades 100-1, 100-2, accelerator blades 101-1, 101-2, and storage blades 102-1, 102-2.

The PIN blades 105-1, 105-2 apply data size reduction processing such as encoding/decoding or compression/restoration to the input data. In addition, the PIN blades 105-1, 105-2 perform small processing, which has been required to be processed by the CPU in related art, at a network line rate instead of the CPU. In addition, the PIN blades 105-1, 105-2 have a simple circuit switching function.

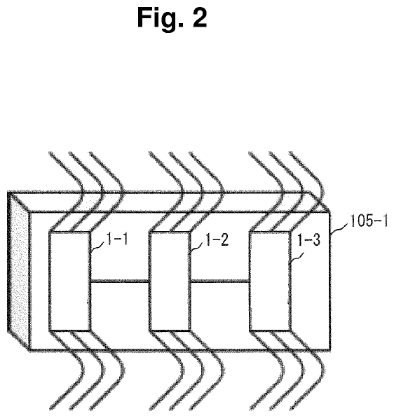

FIG. 2 is a block diagram illustrating a configuration of the PIN blade 105-1. The PIN blade 105-1 includes a plurality of processing blocks 1-1 to 1-3. Each of the processing blocks 1-1 to 1-3 includes a field programmable gate array (FPGA).

Each of the processing blocks 1-1 to 1-3 has a plurality of network physical ports, and a port on one side is connected to the resource blade and a port on the other side is connected to the ToR switch 103-1. The processing blocks 1-1 to 1-3 are connected by a network or a bus and can communicate with each other.

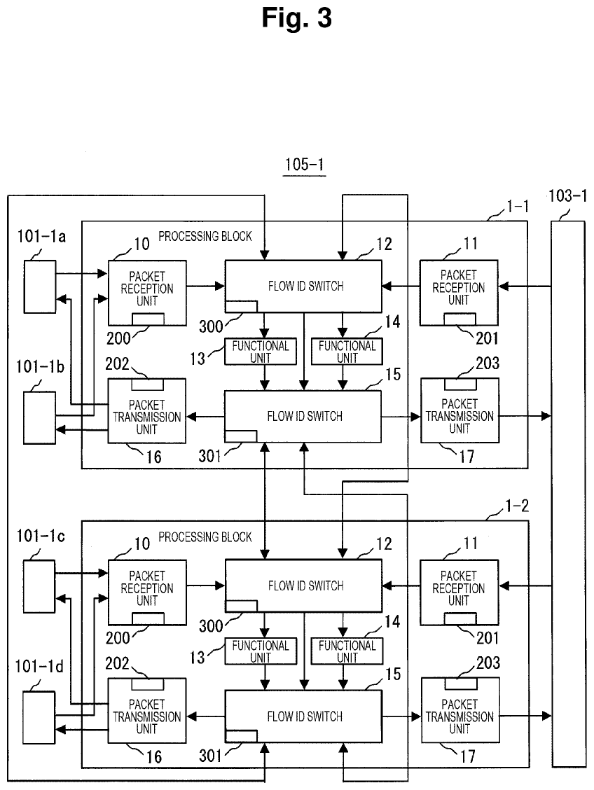

FIG. 3 is a block diagram illustrating a detailed configuration of the PIN blade 105-1. In the example of FIG. 3, two processing blocks 1-1 and 1-2 in the PIN blade 105-1 are described. Each of the processing blocks 1-1 and 1-2 includes a packet reception unit 10 that receives a packet from a subordinate resource blade, a packet reception unit 11 that receives a packet from an upper ToR switch 103-1, a flow ID switch 12 that determines a transfer destination of data of the packets, functional units 13 and 14 that perform predetermined processing on data included in the received packets, a flow ID switch 15 that determines a transfer destination of data of the packets, a packet transmission unit 16 that transmits a packet to the subordinate resource blade, and a packet transmission unit 17 that transmits a packet to the upper ToR switch 103-1.

As illustrated in FIG. 3, in the present embodiment, it is assumed that the accelerator blades 101-1a and 101-1b are connected to the processing block 1-1 of the PIN blade 105-1, and the accelerator blades 101-1c and 101-1d are connected to the processing block 1-2 of the PIN blade 105-1.

The packet reception units 10 of the processing blocks 1-1 and 1-2 receive packets from the connected accelerator blades 101-1a, 101-1b, 101-1c, and 101-1d. In the packet reception units 10, tables 200 in which a transmission destination IP address, a transmission destination port number, and a corresponding flow ID are registered in advance are set. The flow ID is an identifier given to the data to route the data in the PIN blade 105-1.

The packet reception units 10 restore original data from payloads of one or a plurality of packets received from the accelerator blades 101-1a, 101-1b, 101-1c, and 101-1d. The header of the packet includes a transmission destination IP address and a transmission destination port number as transmission destination information. The packet reception units 10 acquire the flow ID corresponding to the transmission destination IP address and the transmission destination port number included in the received packets from the tables 200, add the flow ID to the restored data, and transfer the data to the flow ID switches 12.

On the other hand, the packet reception units 11 of the processing blocks 1-1 and 1-2 receive packets from the connected ToR switch 103-1. In the packet reception units 11, tables 201 in which a transmission destination IP address, a transmission destination port number, and a corresponding flow ID are registered in advance are set.

The packet reception units 11 restore the original data from the payloads of one or a plurality of packets received from the TOR switch 103-1. The packet reception units 11 acquire the flow ID corresponding to the transmission destination IP address and the transmission destination port number included in the received packets from the tables 201, add the flow ID to the restored data, and transfer the data to the flow ID switches 12.

Tables 300 in which a flow ID and information of a corresponding transfer destination are registered in advance are set in the flow ID switches 12 of the processing blocks 1-1 and 1-2. If data is received from the packet reception units 10 and 11 or the flow ID switches 12 and 15 of other processing blocks in the same PIN blade, the flow ID switches 12 acquire information of the transfer destination corresponding to the flow ID added to the data from the tables 300 and transfer the data to the functional units 13 and 14 of the transfer destination specified by the information or the flow ID switches 12 and 15 of the processing blocks of the transfer destination.

The functional units 13 and 14 of the processing blocks 1-1 and 1-2 perform predetermined processing on the data from the flow ID switches 12. Examples of the processing to be performed by the functional units 13 include encoding, decoding, and compression of data, and decompression of compressed data. Examples of the processing to be performed by the functional units 14 include resizing of an image and channel division.

Tables 301 in which a flow ID and information of a corresponding transfer destination are registered in advance are set in the flow ID switches 15 of the processing blocks 1-1 and 1-2. If data is received from the flow ID switches 12, the functional units 13 and 14, or the flow ID switches 12 and 15 of other processing blocks in the same PIN blade, the flow ID switches 15 acquire information of the transfer destination corresponding to the flow ID added to the data from the tables 301 and transfer the data to the packet transmission units 16 and 17 of the transfer destination specified by the information or the flow ID switches 12 and 15 of the processing blocks of the transfer destination.

The packet transmission units 16 of the processing blocks 1-1 and 1-2 transmit packets to the connected accelerator blades 101-1a, 101-1b, 101-1c, and 101-1d. In the packet transmission units 16, tables 202 in which a flow ID and a corresponding transmission destination IP address and transmission destination port number are registered in advance are set.

If data is received from the flow ID switches 15, the packet transmission units 16 packetize the data and acquires the transmission destination IP address and the transmission destination port number corresponding to the flow ID added to the data from the tables 202. The packet transmission units 16 set a transmission destination IP address and a transmission destination port number in the headers of the created packets and transmit the packets to the accelerator blades 101-1a, 101-1b, 101-1c, and 101-1d.

The packet transmission units 17 of the processing blocks 1-1 and 1-2 transmit packets to the connected ToR switch 103-1. In the packet transmission units 17, tables 203 in which a flow ID and a corresponding transmission destination IP address and transmission destination port number are registered in advance are set.

If data is received from the flow ID switches 15, the packet transmission units 17 packetize the data and acquire the transmission destination IP address and the transmission destination port number corresponding to the flow ID added to the data from the tables 203. The packet transmission units 17 set the transmission destination IP address and the transmission destination port number in the headers of the created packets and transmit the packets to the ToR switch 103-1.

Although the PIN blade 105-1 is described as an example in FIGS. 2 and 3, a configuration of the PIN blade 105-2 is also similar to that of the PIN blade 105-1.

Next, a specific example of operation of the PIN blades 105-1, 105-2 of the present embodiment will be described.

### Data Size Reduction Processing

First, an example of a case where data is transferred from the accelerator blade 101-1 to the accelerator blade 101-2 in FIG. 1 will be described.

The packet reception unit 10 of the processing block in the PIN blade 105-1 restores the original data from the payload of the packet received from the accelerator blade 101-1. The packet reception unit 10 acquires the flow ID corresponding to the transmission destination IP address and the transmission destination port number included in the packet from the table 200, adds the flow ID to the restored data, and transfers the data to the flow ID switch 12.

If the data is received from the packet reception unit 10, the flow ID switch 12 of the processing block in the PIN blade 105-1 acquires information of the transfer destination corresponding to the flow ID added to the data from the table 300 and transfers the data to the transfer destination designated by the information. Here, it is assumed that the transfer destination is the functional unit 13.

If the data is received from the flow ID switch 12, the functional unit 13 of the processing block in the PIN blade 105-1 compresses the data and transfers the compressed data to the flow ID switch 15.

If the data is received from the functional unit 13, the flow ID switch 15 of the processing block in the PIN blade 105-1 acquires information of the transfer destination corresponding to the flow ID added to the data from the table 301 and transfers the data to the transfer destination designated by the information. Here, it is assumed that the transfer destination is the packet transmission unit 17.

If the data is received from the flow ID switch 15, the packet transmission unit 17 of the processing block in the PIN blade 105-1 packetizes the data and acquires the transmission destination IP address and the transmission destination port number corresponding to the flow ID added to the data from the table 203. The packet transmission unit 17 sets the transmission destination IP address and the transmission destination port number in the header of the created packet and transmits the packet to the ToR switch 103-1 via the network.

If the packet is received from the PIN blade 105-1, the ToR switch 103-1 refers to the transmission destination IP address set in the packet header and transmits the packet to the spine switch 104 via the network.

If the packet is received from the TOR switch 103-1, the spine switch 104 refers to the transmission destination IP address set in the packet header and transmits the packet to the ToR switch 103-2 via the network.

If the packet is received from the spine switch 104, the TOR switch 103-2 refers to the transmission destination IP address set in the packet header and transmits the packet to the PIN blade 105-2 via the network.

The packet reception unit 11 of the processing block in the PIN blade 105-2 restores the original data from the payload of the packet received from the TOR switch 103-2. The data restored here is the data compressed by the PIN blade 105-1. The packet reception units 11 acquire the flow ID corresponding to the transmission destination IP address and the transmission destination port number included in the received packets from the tables 201, add the flow ID to the restored data, and transfer the data to the flow ID switches 12.

If the data is received from the packet reception unit 11, the flow ID switch 12 of the processing block in the PIN blade 105-2 acquires information of the transfer destination corresponding to the flow ID added to the data from the table 300 and transfers the data to the transfer destination designated by the information. Here, it is assumed that the transfer destination is the functional unit 13.

If the data is received from the flow ID switch 12, the functional unit 13 of the processing block in the PIN blade 105-2 decompresses the compressed data to restore the original data and transfers the data to the flow ID switch 15.

If the data is received from the functional unit 13, the flow ID switch 15 of the processing block in the PIN blade 105-2 acquires information of the transfer destination corresponding to the flow ID added to the data from the table 301 and transfers the data to the transfer destination designated by the information. Here, it is assumed that the transfer destination is the packet transmission unit 16.

If the data is received from the flow ID switch 15, the packet transmission unit 16 of the processing block in the PIN blade 105-2 packetizes the data and acquires the transmission destination IP address and the transmission destination port number corresponding to the flow ID added to the data from the table 202. The packet transmission unit 16 sets a transmission destination IP address and a transmission destination port number in the header of the created packet and transmits the packet to the accelerator blade 101-2.

As described above, in the present embodiment, the data is compressed and transmitted in a route from the PIN blade 105-1 to the PIN blade 105-2 via the ToR switch 103-1, the spine switch 104, and the ToR switch 103-2, so that it is possible to reduce load of the network and reduce a possibility of congestion in the network.

### Circuit Switching

Note that data size reduction is also effective in communication between resource blades connected to the same PIN blade. In addition, in a case of communication between the resource blades connected to the same PIN blade, communication between the resource blades can be implemented without passing through the TOR switch by a circuit switching function of the PIN blade.

For example, in a case where data is transferred from the accelerator blade 101-1a to the accelerator blade 101-1c in FIG. 2, the packet reception unit 10 of the processing block 1-1 in the PIN blade 105-1 restores the original data from the payload of the packet received from the accelerator blade 101-1a. The packet reception unit 10 adds a flow ID to the restored data and transfers the data to the flow ID switch 12.

If the data is received from the packet reception unit 10, the flow ID switch 12 of the processing block 1-1 in the PIN blade 105-1 acquires information of the transfer destination corresponding to the flow ID added to the data from the table 300 and transfers the data to the transfer destination designated by the information. Here, it is assumed that the transfer destination is the functional unit 13.

If the data is received from the flow ID switch 12, the functional unit 13 of the processing block 1-1 in the PIN blade 105-1 compresses the data and transfers the compressed data to the flow ID switch 15.

If the data is received from the functional unit 13, the flow ID switch 15 of the processing block 1-1 in the PIN blade 105-1 acquires information of the transfer destination corresponding to the flow ID added to the data from the table 301 and transfers the data to the transfer destination designated by this information. Here, it is assumed that the transfer destination is the flow ID switch 12 of the processing block 1-2 in the PIN blade 105-1.

If the data is received from the processing block 1-2 in the PIN blade 105-1, the flow ID switch 12 of the processing block 1-1 acquires information of the transfer destination corresponding to the flow ID added to the data from the table 300 and transfers the data to the transfer destination designated by the information. Here, it is assumed that the transfer destination is the functional unit 13.

If the data is received from the flow ID switch 12, the functional unit 13 of the processing block 1-2 in the PIN blade 105-1 decompresses the compressed data to restore the original data and transfers the data to the flow ID switch 15.

If the data is received from the functional unit 13, the flow ID switch 15 of the processing block 1-2 in the PIN blade 105-1 acquires information of the transfer destination corresponding to the flow ID added to the data from the table 301 and transfers the data to the transfer destination designated by this information. Here, it is assumed that the transfer destination is the packet transmission unit 16.

If the data is received from the flow ID switch 15, the packet transmission unit 16 of the processing block 1-2 in the PIN blade 105-1 packetizes the data and acquires the transmission destination IP address and the transmission destination port number corresponding to the flow ID added to the data from the table 202. The packet transmission unit 16 sets the transmission destination IP address and the transmission destination port number in the header of the created packet and transmits the packet to the accelerator blade 101-1C.

In the related art, it is known that fluctuation of a communication delay greatly affects quality of service. A general ToR switch performs packet-switched communication, and thus, a packet queue is generated, and a delay time fluctuates.

On the other hand, in the present embodiment, the delay time can be made constant by providing the PIN blade with a circuit switching function. In other words, in a case of communication between the resource blades connected to the same PIN blade, a direct path can be created between the resource blades connected to the same PIN blade by transmitting and receiving data between the flow ID switches without using the TOR switch.

### Offloading of Processing

Next, an example of a case where image processing is required in a case where image data is transferred from the accelerator blade 101-1 to the accelerator blade 101-2 in FIG. 1 will be described.

The packet reception unit 10 of the processing block in the PIN blade 105-1 restores the original image data from the payload of the packet received from the accelerator blade 101-1. The packet reception unit 10 adds the flow ID to the restored image data and transfers the image data to the flow ID switch 12.

If the image data is received from the packet reception unit 10, the flow ID switch 12 of the processing block in the PIN blade 105-1 acquires information of the transfer destination corresponding to the flow ID added to the image data from the table 300 and transfers the image data to the transfer destination designated by this information. Here, it is assumed that the transfer destination is the functional unit 14.

If the image data is received from the flow ID switch 12, the functional unit 14 of the processing block in the PIN blade 105-1 performs predetermined processing on the image data and transfers the image data to the flow ID switch 15. Examples of the processing to be performed by the functional units 14 include resizing of an image and channel division.

If the image data is received from the functional unit 14, the flow ID switch 15 of the processing block in the PIN blade 105-1 acquires information of the transfer destination corresponding to the flow ID added to the image data from the table 301 and transfers the image data to the transfer destination designated by this information. Here, it is assumed that the transfer destination is the packet transmission unit 17.

If the image data is received from the flow ID switch 15, the packet transmission unit 17 of the processing block in the PIN blade 105-1 packetizes the image data and acquires the transmission destination IP address and the transmission destination port number corresponding to the flow ID added to the image data from the table 203. The packet transmission unit 17 sets the transmission destination IP address and the transmission destination port number in the header of the created packet and transmits the packet to the TOR switch 103-1 via the network.

The operation of the ToR switch 103-1, the spine switch 104, and the ToR switch 103-2 has been described above.

The packet reception unit 11 of the processing block in the PIN blade 105-2 restores the image data from the payload of the packet received from the ToR switch 103-2. The packet reception unit 11 adds the flow ID to the restored image data and transfers the image data to the flow ID switch 12.

If the image data is received from the packet reception unit 11, the flow ID switch 12 of the processing block in the PIN blade 105-2 acquires information of the transfer destination corresponding to the flow ID added to the image data from the table 300 and transfers the image data to the transfer destination designated by this information. Here, it is assumed that the transfer destination is the flow ID switch 15.

If the image data is received from the flow ID switch 12, the flow ID switch 15 of the processing block in the PIN blade 105-2 acquires information of the transfer destination corresponding to the flow ID added to the image data from the table 301 and transfers the image data to the transfer destination designated by this information. Here, it is assumed that the transfer destination is the packet transmission unit 16.

If the image data is received from the flow ID switch 15, the packet transmission unit 16 of the processing block in the PIN blade 105-2 packetizes the image data and acquires the transmission destination IP address and the transmission destination port number corresponding to the flow ID added to the image data from the table 202. The packet transmission unit 16 sets a transmission destination IP address and a transmission destination port number in the header of the created packet and transmits the packet to the accelerator blade 101-2.

As described above, in the present embodiment, the image data is processed by the PIN blade 105-1 in a route from the accelerator blades 101-1 to the accelerator blade 101-2 via the PIN blade 105-1, the TOR switch 103-1, the spine switch 104, the TOR switch 103-2, and the PIN blade 105-2.

In related art, small processing such as preprocessing and post-processing is generally performed by a CPU not by an accelerator. For example, image processing is generally performed by a graphics processing unit (GPU), but there is a case where resizing of an image, channel division, and the like, are performed by a CPU. In such a case, access to a CPU blade occurs in the DDC, which causes access tightness. In the present embodiment, the PIN blade takes over the processing instead of the CPU, so that the access to the CPU blade can be reduced, and the load of the network can be reduced.

Offloading of processing is also effective for communication between resource blades connected to the same PIN blade. For example, in a case where data is transferred from the accelerator blade 101-1a to the accelerator blade 101-1c in FIG. 2, the packet reception unit 10 of the processing block 1-1 in the PIN blade 105-1 restores image data from the payload of a packet received from the accelerator blade 101-1a. The packet reception unit 10 adds a flow ID to the image data and transfers the image data to the flow ID switch 12.

If the image data is received from the packet reception unit 10, the flow ID switch 12 of the processing block 1-1 in the PIN blade 105-1 acquires information of the transfer destination corresponding to the flow ID added to the image data from the table 300 and transfers the image data to the transfer destination designated by the information. Here, it is assumed that the transfer destination is the functional unit 14.

If the image data is received from the flow ID switch 12, the functional unit 14 of the processing block 1-1 in the PIN blade 105-1 performs predetermined processing on the image data and transfers the image data to the flow ID switch 15.

If the image data is received from the functional unit 14, the flow ID switch 15 of the processing block 1-1 in the PIN blade 105-1 acquires the information of the transfer destination corresponding to the flow ID added to the image data from the table 301 and transfers the data to the transfer destination designated by this information. Here, it is assumed that the transfer destination is the flow ID switch 15 of the processing block 1-2 in the PIN blade 105-1.

If the image data is received from the processing block 1-2 in the PIN blade 105-1, the flow ID switch 15 of the processing block 1-1 acquires information of the transfer destination corresponding to the flow ID added to the image data from the table 301 and transfers the image data to the transfer destination designated by the information. Here, it is assumed that the transfer destination is the packet transmission unit 16.

If the image data is received from the flow ID switch 15, the packet transmission unit 16 of the processing block 1-2 in the PIN blade 105-1 packetizes the image data and acquires the transmission destination IP address and the transmission destination port number corresponding to the flow ID added to the image data from the table 202. The packet transmission unit 16 sets the transmission destination IP address and the transmission destination port number in the header of the created packet and transmits the packet to the accelerator blade 101-1c.

### INDUSTRIAL APPLICABILITY

Embodiments of the present invention can be applied to a disaggregated computing technology in which resource blades are interconnected by a network.

### REFERENCE SIGNS LIST

1-1 to 1-3 Processing block
10, 11 Packet reception unit
12, 15 Flow ID switch
13, 14 Functional unit
16, 17 Packet transmission unit
100-1, 100-2 CPU blade
101-1, 101-1a, 101-1b, 101-1c, 101-1d, 101-2 Accelerator blade
102-1, 102-2 Storage blade
103-1, 103-2 Top-of-rack switch
104 Spine switch
105-1, 105-2 PIN blade
200 to 203, 300, 301 Table

1-4. (canceled)

5. A computing system comprising:
a plurality of top-of-rack switches connected to subordinate resource blades;
a spine switch connecting the plurality of top-of-rack switches; and
a plurality of processing-in-network (PIN) blades respectively arranged between the plurality of top-of-rack switches and the subordinate resource blades,
wherein each of the PIN blades includes a plurality of processing blocks, and
wherein each of the plurality of processing blocks includes:
a first packet receiver configured to receive a first packet from a respective subordinate resource blade;
a first packet transmitter configured to transmit a second packet to the respective subordinate resource blade;
a second packet receiver configured to receive a third packet from an upper top-of-rack switch of the plurality of top-of-rack switches;
a second packet transmitter configured to transmit a fourth packet to the upper top-of-rack switch; and
a functional processor configured to perform predetermined processing on data included in the first packet or the third packet to obtain processed data; and
a flow identification (ID) switch configured to determine a transfer destination of the data included in the first packet or the third packet or the processed data, from among the first packet transmitter, the second packet transmitter, or the functional processor, and transfer the data included in the first packet or the third packet or the processed data to the transfer destination.

6. The computing system according to claim 5,
wherein the plurality of processing blocks in each of the plurality of PIN blades are connected to each other, and
a respective flow ID switch of each of the plurality of processing blocks is configured to receive data from another processing block of the plurality of processing blocks in a same PIN blade in addition to the data from the first packet or the third packet, and determine a transfer destination of the data received from the another processing block from among the first packet transmitter, the second packet transmitter, or the functional processor, and transfer the data received from the another processing block to the transfer destination.

7. The computing system according to claim 5,
wherein the first packet receiver is configured to restore the data from the first packet received from the respective subordinate resource blade, add a flow ID corresponding to transmission destination information included in the first packet to the data from the first packet to obtain second data, and transfer the second data to the flow ID switch.

8. The computing system according to claim 7,
wherein the flow ID switch is configured to determine the transfer destination of the data from the first packet based on the flow ID added to the data from the first packet.

9. The computing system according to claim 8,
wherein the first packet transmitter is configured to packetize the data from the first packet and received from the flow ID switch to generate a fourth packet, set the transmission destination information corresponding to the flow ID, and transmit the fourth packet to the respective subordinate resource blade.

10. The computing system according to claim 8,
wherein the second packet transmitter is configured to packetize the data from the first packet and received from the flow ID switch to generate a fifth packet, set the transmission destination information corresponding to the flow ID, and transmit the fifth packet to the upper top-of-rack switch.

11. The computing system according to claim 5,
wherein the second packet receiver is configured to restore the data from the third packet and received from the upper top-of-rack switch, add a flow ID corresponding to transmission destination information included in the third packet to the data from the third packet to obtain third data, and transfer the third data to the flow ID switch.

12. The computing system according to claim 11,
wherein the flow ID switch is configured to determine the transfer destination of the data from the third packet based on the flow ID added to the data from the third packet.

13. The computing system according to claim 12,
wherein the first packet transmitter is configured to packetize the data from the third packet and received from the flow ID switch to generate a sixth packet, set the transmission destination information corresponding to the flow ID, and transmit the sixth packet to the respective subordinate resource blade.

14. The computing system according to claim 12,
wherein the second packet transmitter is configured to packetize the data from the third packet and received from the flow ID switch to generate a seventh packet, set the transmission destination information corresponding to the flow ID, and transmit the seventh packet to the upper top-of-rack switch.

15. The computing system according to claim 5,
wherein the functional processor is configured to perform compression of data, decompression of compressed data, resizing of an image, or channel division of an image on the data from the first packet or the third packet.

16. A computing system comprising:
a plurality of top-of-rack switches connected to subordinate resource blades;
a spine switch connecting the plurality of top-of-rack switches; and
a plurality of processing-in-network (PIN) blades respectively arranged between the plurality of top-of-rack switches and the subordinate resource blades,
wherein each of the PIN blades includes a plurality of field programmable arrays (FPGAs), and
wherein each of the plurality of field programmable arrays (FPGAs) is configured to:
receive a first packet from a respective subordinate resource blade or an upper top-of-rack switch of the plurality of top-of-rack switches;
perform predetermined processing on data included in the first packet to obtain processed data; and
transmit the processed data to the respective subordinate resource blade or the upper top-of-rack switch.

17. The computing system according to claim 16, wherein each of the plurality of FPGAs is connected to each other and further configured to:
receive data from another FPGA of the plurality of FPGAs.

18. The computing system according to claim 16, wherein each of the plurality of FPGAs is further configured to:
restore the data from the first packet; and
add a flow ID corresponding to transmission destination information included in the first packet to the data from the first packet.

19. The computing system according to claim 18, wherein each of the plurality of FPGAs is configured to transmit the processed data to the respective subordinate resource blade or the upper top-of-rack switch by:
packetizing the processed data to generate a second packet;
setting the transmission destination information corresponding to the flow ID; and
transmitting the second packet to the respective subordinate resource blade or the upper top-of-rack switch.

20. The computing system according to claim 16, wherein the predetermined processing comprises:
compression of data, decompression of compressed data, resizing of an image, or channel division of an image.
